(19) United States
(12) Patent Application Publication
(10) Pub. No.: US 2012/0202632 A1
(43) Pub. Date: Aug. 9, 2012

(54) BAND DRIVE SYSTEM

(76) Inventors: Nathan A. Scolari, Greenville, SC (US); George Reiter, Taylors, SC (US)

(21) Appl. No.: 13/366,624

(22) Filed: Feb. 6, 2012

Related U.S. Application Data
(60) Provisional application No. 61/439,603, filed on Feb. 4, 2011.

(51) Int. Cl. F16H 7/02

(52) U.S. Cl. 474/153

(57) ABSTRACT

This invention is directed to a drive system using a metal band having a curved bias perpendicular to its long axis. Openings can be included along the band's long axis for receiving pins disposed on a gear. The gear's pins drive the band allowing the energy from the drive gear to both push and pull the band due to the curve bias of the band.

### CLAIM OF PRIORITY

This application claims priority on U.S. Provisional Patent Application 61/439,603, filed Feb. 4, 2011.

### FIELD OF THE INVENTION

This invention is directed to a tape drive system allowing for the tape to be pulled as well as pushed to exert force.

### BACKGROUND OF THE INVENTION

In many applications, belts, chains or other flexible material are used to transfer energy from a drive system to another component. For example, in the personal mobility device industry (e.g., bicycles and scooters), pedals or other articles come in contact with the rider's feet to transfer power from the rider's legs to the pedals, to a chain, and ultimately to the wheels. Traditionally, a chain is used to connect a sprocket attached to the pedals to the hub of the wheel to provide a driving force. The rotation of the sprocket pulls the chain, thereby transferring power. However, energy transfer can only travel one way since chains are pulled and cannot be pushed.

In one type of drive system, pedals are used which move up and down in a rotary fashion, so that it would be desirable that, when a pedal is forced downward, a chain, a belt, or other flexible material could be used to drive the wheels. However, energy can only be transferred from the pedals in one direction downward, transferring energy to the wheels while the upstroke is idle in preparation of the next stroke. Further, the downstroke also causes the alternating pedal upwards to prepare it for another downstroke. This configuration requires that the pedals operate in conjunction.

It would be advantageous for each pedal to operate independently. However, since a chain cannot be pushed, it is necessary for the pedals to work in cooperation. Additionally, chains, belts, and other such drive components tend to have fixed lengths and are not allowed to be easily shared. Further, chains are heavy and not very flexible. Additionally, belts straps while flexible, are not as strong or desirable as materials made from metal.

It is an object of this invention to provide for a drive component that can transfer energy by pushing and pulling the drive component.

It is another object of the present invention to provide a flexible and durable drive component that easily gathers for storage.

### DESCRIPTION OF THE DRAWINGS

The present invention is more easily understood by referring to the following drawings incorporated by reference:

FIG. 1A is a perspective view of the invention;

FIG. 1B is a bottom view of the invention;

FIG. 1C is a perspective view of the invention;

FIGS. 2A through 2C are perspective views of the invention;

FIG. 3A is a cross-section of the invention;

FIGS. 3B and 3C are bottom views and a cross-section of the invention;

FIG. 4A is one embodiment where the invention is used;

FIG. 4B is a perspective view of the invention;

FIG. 5 is a perspective view of the invention;

FIG. 6 is a cross-sectional view of the invention; and,

FIG. 7 is a cross-sectional view of the invention.

### DESCRIPTION OF THE INVENTION

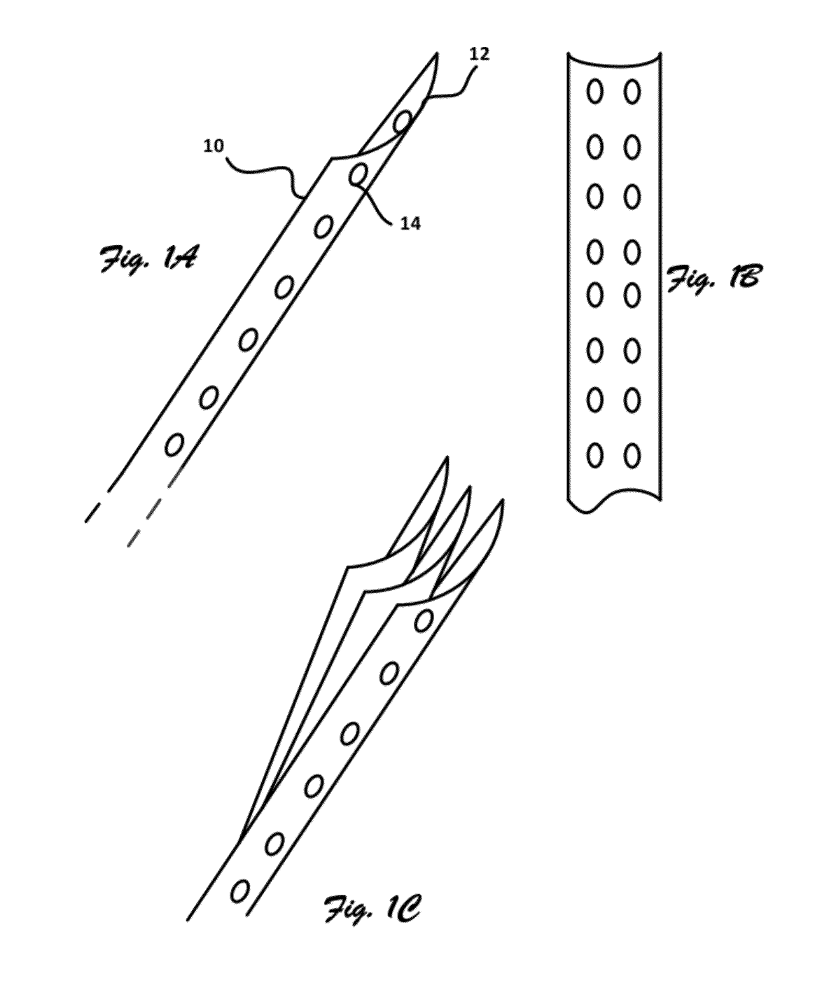

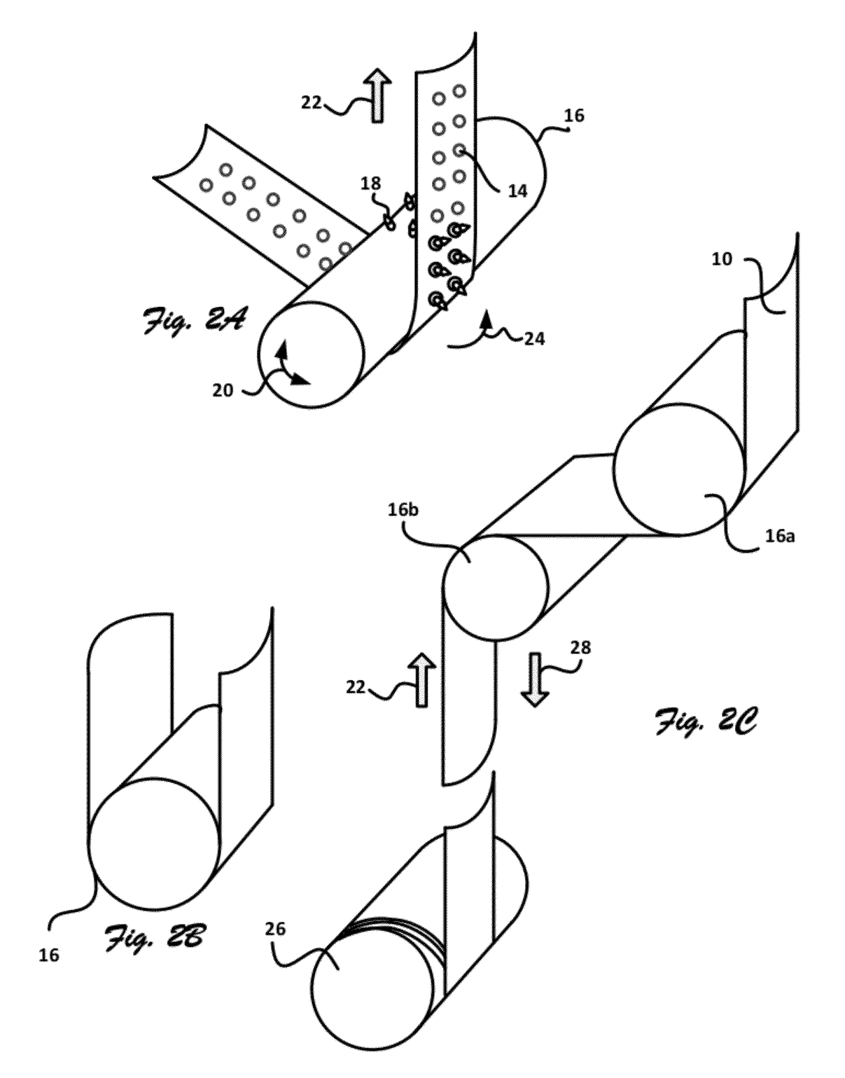

Referring to FIG. 1A, a metal band 10 is provided having a generally curved shape 12 perpendicular to the metal band's long axis. A plurality of openings 14 are defined in the metal band. The openings can be in a single linear arrangement or in multiple linear arrangement, as shown in FIG. 1B. The metal band can be used by itself or in a layered configuration, as shown in FIG. 1C, to increase strength. It should be noted that when in a layered configuration, each band nests within the adjacent band. Further, the openings in the outer bands can have increased spacing between openings to compensate for the increased diameter of the path traveled by the outer band in comparison to the inner band when multiple bands travel around a gear, idler or guide.

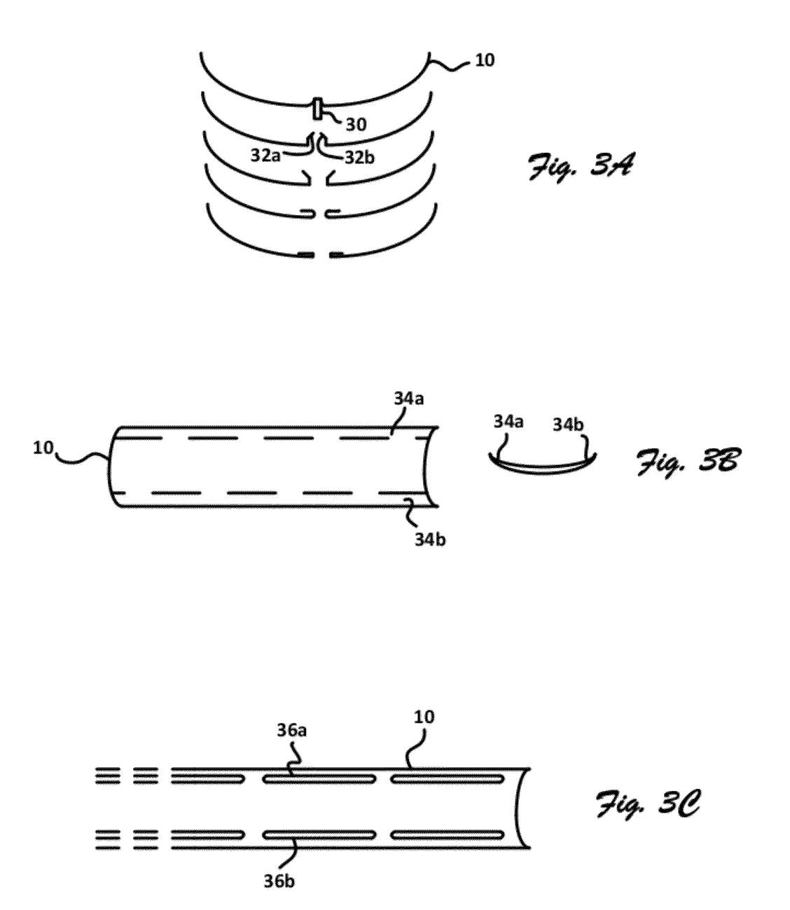

Referring to FIG. 2A, an example of the bands traveling around a gear is shown. Circular gear 16 is shown having a plurality of pins 18. The pins are received in holes 14 and the bands travel in direction 20.

When the band engages the drive, the band is forced flat as it contacts with the gear. Once the band ceases contact with the gear, it returns to its curved shape. This curved shape allows the band to extend in a direction 22 when the gear rotates in direction 24. This allows the band to be pushed.

Referring to FIG. 2B, the present invention provides the ability for the band to be directed in directions having an angular relation that greater than 180°. Gear, idler or guide 16 in combination with the bands ability to flatten, allows the band to be redirected.

Referring to FIG. 2C, band 10 is redirected by gear, idler, or guide 16a and 16b. Further, a spool 26 can gather the band, and also bias the band to wrap around the spool. Therefore, if the band is pulled in direction 22, the bias of the spooler will pull the band in a direction 28 when the upward force on the band is sufficiently reduced.

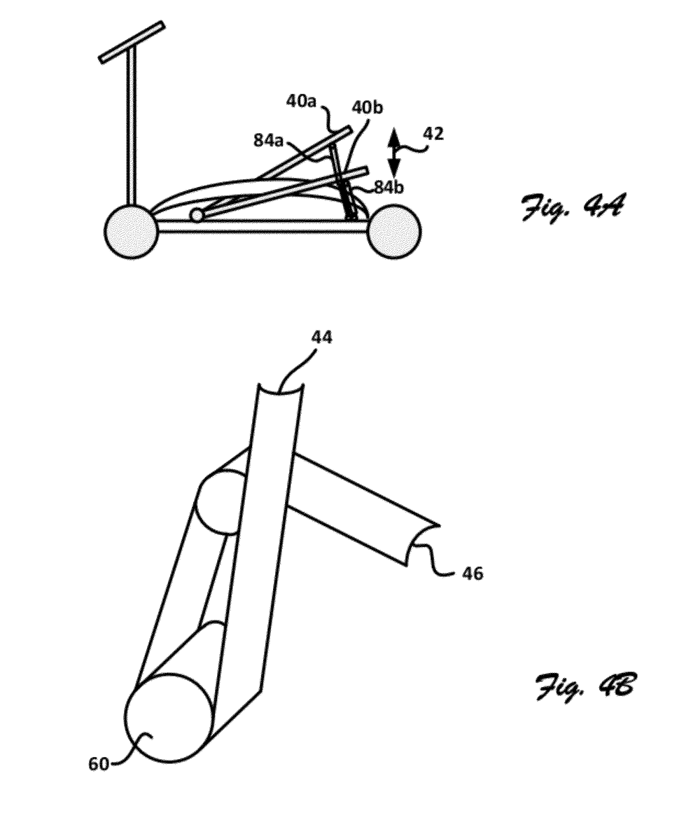

Referring now to FIG. 3A, a configuration for producing the openings in the band is shown. Manufacturing tool 30 is used to create a hole in band 10. Portions 32a and 32b are created and bend backwards to form the opening as well as used to reinforce the opening.

When the band is gathered around a spooler or other such component, the band can bind against the adjacent layers. To prevent the binding of the band, as well as to promote the adjacent layers of bands to slide across each other, the edges of the tape can be thinned and/or tapered. Edges 34a and 34b (FIG. 3B) are thinned to facilitate the band sliding along adjacent layers.

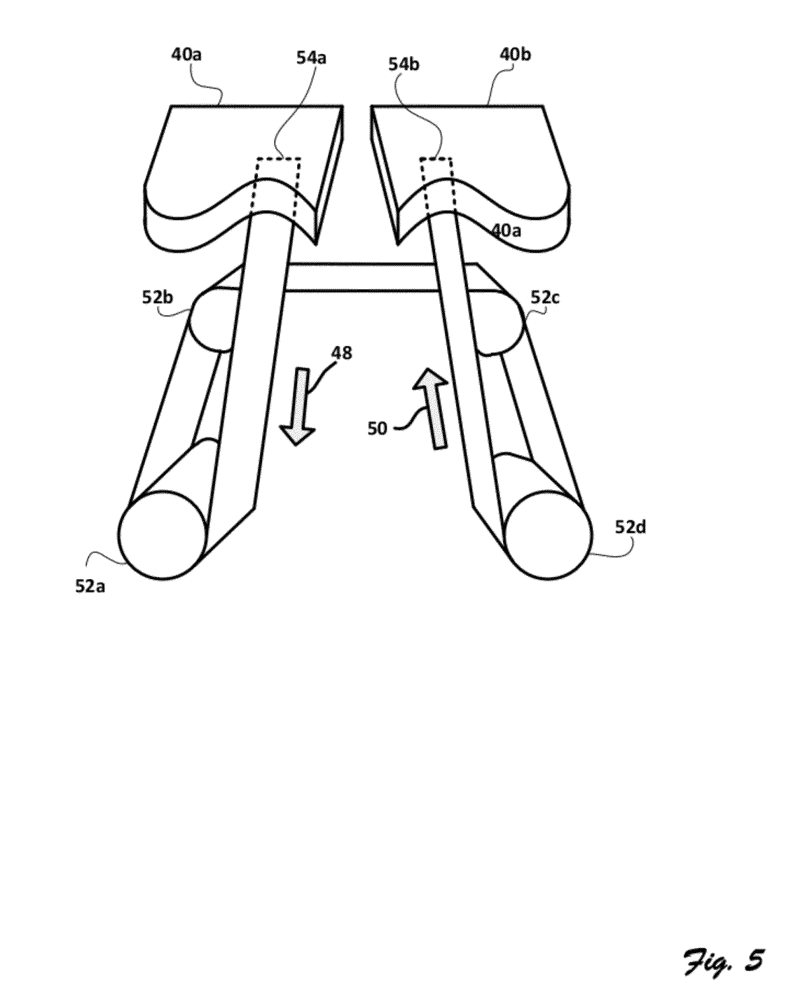

Referring to FIG. 4A, a scooter with a pedal drive is shown. Pedals 40a and 40b move in direction 42. In order to convert this energy to the wheels, the band can be directed as shown in FIG. 4B due to its flexibility. A first end 44 can be carried by the pedals and second end 46 is carried by the wheels. By using gears and the spooler, each pedal can be used to transfer energy from the pedal to the wheel and recover independently from the other pedal.

In FIG. 4B, the band, due to its flexibility, can be directed as shown. A first end 44 can be carried by the pedals and end 46 operably associated with a drive system to wheels. By using gears and the spooler 60, each pedal can be used to transfer energy from the pedal to the wheel, and recover independently from the other pedal.

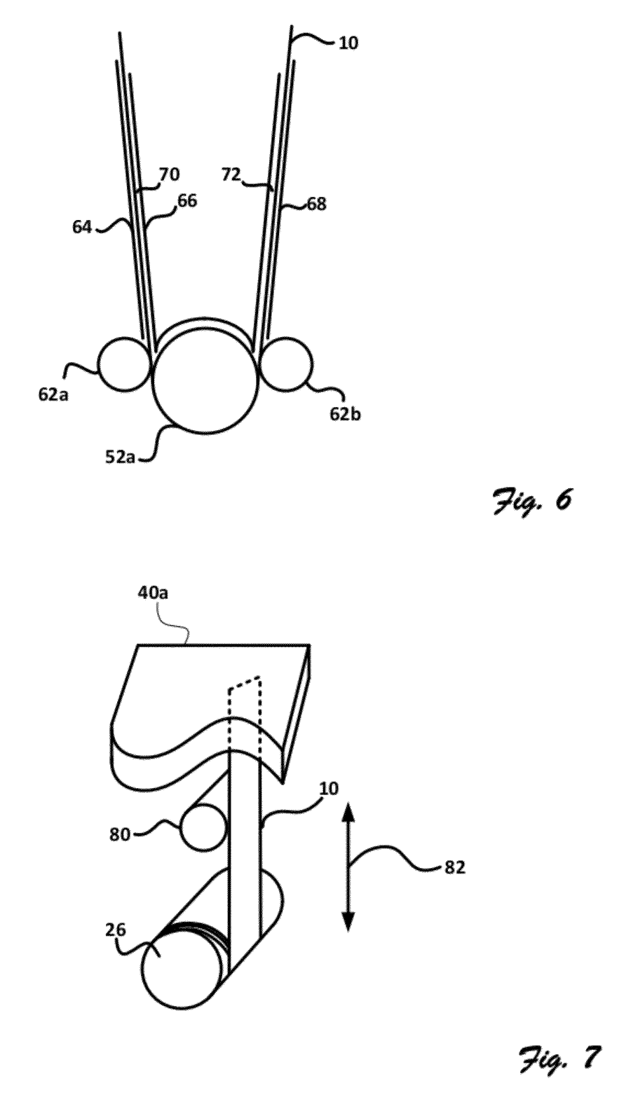

Referring to FIG. 5, the ability of the bands to work in conjunction with pedals 40a and 40b in cooperation is shown. In one embodiment, pedal 40a is a first energy source and pedal 40b is a second energy source. The energy sources need not be pedals, but can be other reciprocating or rotary energy sources.

The band is attached to the pedals at attachment point 54a and 54b, respectively. The bands can be attached to the pedals through bolts, screws, or placed in a slot in the pedal to secure the bands to the pedal. When the rider presses down on pedal 40a, the pedal places a force 48 on the band. Due to its curved bias, the band can push the other pedal 40b in a direction 50 as it travels around the pulleys 52a through 52d. Pulleys 52a or 52d, or both, can be attached to a drive system which transfers energy from the pulleys to a drive shaft which in turn can rotate mechanical items such as the wheels of a scooter or a bike. Drive systems using this invention can include spiral bevel gears, differential, worm drive and the like. In one embodiment, the pulleys 52a or 52b can be operably associated with a gear (shown as reference No. 62 in FIG. 8 of United States Patent Application Publication 2011/0057411, incorporated by reference) so that energy is transferred from the rider to the rear wheel. In one embodiment, pulleys 52a and 52d can be operably associated with rear chain and gear drive system as shown in FIG. 11 of United States Patent Application Publication 2011/0057412, incorporated by reference.

Referring to FIG. 6, support idlers 62a and 62b can be included to assist the band from buckling under downward force. A housing defined by a first outer wall 64, an inner member 66, and an second outer wall 68 can define a first channel 70 and a second channel 72 in which the band may travel. These channels further assist the band from buckling under a load. The band would contact the inner walls included in the channels preventing the band from buckling.

Referring to FIG. 7, band 10 is attached to pedal 40a at one end and spooler 26 at the other end. The spooler is biased to cause the band to wrap around the spooler when traveling downward in response to the pedal being depressed by the rider. When the pedal travel upwards, the band unwraps from the spooler and extends upward. A drive gear 80 can be operably connected to the band so that when the band travels upward or downward, the drive gear can transfer energy to a drive system connected to the drive gear. In one embodiment, the drive gear will engage in one direction to transfer energy to the drive system and will freely rotate in the other direction without transferring energy to the drive system. In this embodiment, two band system can be used, one for each pedal, so that the pedals can transfer energy to the drive system independently. In one embodiment, the pedals are biased upwards using upward biasing members 82a and 82b (FIG. 4A) which can be pistons, springs, or the like, to allow the pedal to return to an upward position when the pedal is no longer depressed by the rider. This allows the band to unwrap from the spooler, the pedal to travel upwards and resets the pedal for the rider to exert force downward on the pedal.

While a preferred embodiment of the invention has been described using specific terms, such description is for illustrative purposes only, and it is to be understood that changes and variations may be made without departing from the spirit or scope of the following claims.

What is claimed is:

1. A drive system for a personal mobility device having a support platform, drive system, a first and second pedal, and plurality of wheels comprising:
a band having a curved bias perpendicular to the long axis of the band said band having a first end attached to said first pedal and a second end attached to said second pedal;
a plurality of openings defined in the said band along its axis;
a drive gear having a plurality of pins that are received in said openings for transferring energy to said band to said drive gear;
a first travel path where said band travels downward when said pedal is depressed by a rider;
a second travel path about 180° in relation to said first travel path including a first pulley redirecting said band to said second travel path;
a third travel path about 90° to said second travel path including a second pulley redirecting said band to said third travel path;
a fourth travel path about 90° to said third travel path including a third pulley redirecting said band to said fourth travel path;
a fifth travel path about 180° in relation to said fourth travel path including a fourth pulley redirecting said band to said second pedal so that said band can transfer force generated from said first pedal to said drive system and raise said second pedal.

2. The system of claim 1 including a plurality of reinforcement bands layered against said band.

3. The system of claim 2 wherein said openings in said reinforcement bands are spaced a greater distance than the opening of an inner layer to account for greater diameter travel paths around said pulleys.

4. The system of claim 1 including a first biasing member attached to said first pedal and a second biasing member attached to said second pedal for biasing said pedals in an upward position.

5. The system of claim 1 wherein said openings are created by making a hole in said band, extending portions of said band adjacent to said opening inward, bending said portions about 180° around said openings to provide reinforcement to said edges of said opening.

6. The system of claim 1 wherein said band is metal.

7. The system of claim 1 wherein said plurality of openings defined in the said band along its axis are arranged in rows.

8. The drive system of claim 1 including a housing for receiving said band wherein said band travels in the interior of said housing.

9. A drive system for a personal mobility device having a support platform, drive system, a first and second pedal and plurality of wheels comprising:
a band having a curved bias perpendicular to the long axis of the band. said band having a first end attached to said first pedal;
a plurality of openings defined in the said band along its axis;
a spooler attached to a second end of said band, said spooler biased to cause said band to wrap around said spooler when said band travels toward said spooler;
a drive gear operably associated with said band having a plurality of pins that are received in said openings for transferring energy from said band to said drive gear; and,
a vertical travel path having a first direction wherein said band travels downward when said pedal is depressed so that said band rotates said drive gear and gathers about said spooler and a second direction wherein said band travels upwards unwinding from said spooler and said drive gear freely spins.

10. The system of claim 1 including a plurality of reinforcement bands layered against said band.

11. The system of claim 9 including a plurality of reinforcement bands layered against said band.

12. The system of claim 10 wherein said openings in said reinforcement bands are spaced a greater distance than the opening of an inner layer to account for greater diameter travel paths around said pulleys.

13. The system of claim 9 wherein said openings are created by making a hole in said band, extending portions of said band adjacent to said opening inward, bending said portions about 180° around said openings to provide reinforcement to said edges of said opening.

14. The system of claim 9 wherein said band is metal.

15. The system of claim 9 wherein said plurality of openings defined in the said band along its axis are arranged in rows.

16. A drive system comprising:
a band having a curved bias perpendicular to the long axis of the band, said band having a first end attached to an energy source;
a plurality of openings defined in the said band along its axis;
a drive gear having a plurality of pins that are received in said openings for transferring energy to said band to said drive gear;
a first travel path where said band travels downward when said energy source exerts energy on said band;
a second travel path about 180° in relation to said first travel path including a first pulley redirecting said band to said second travel path;
a third travel path about 90° to said second travel path including a second pulley redirecting said band to said third travel path;
a fourth travel path about 90° to said third travel path including a third pulley redirecting said band to said fourth travel path;
a fifth travel path about 180° in relation to said fourth travel path including a fourth pulley redirecting said band to a second energy source so that said band can transfer force generated from said first and said second energy source to aid drive gear.

17. The system of claim 15 including a plurality of reinforcement bands layered against said band.

18. The system of claim 15 wherein said openings in said reinforcement bands are spaced a greater distance than the opening of an inner layer to account for greater diameter travel paths around said pulleys.

19. The system of claim 15 including a plurality of pulleys in contact with said band for guiding said band in a plurality of directions.

20. The system of claim 15 wherein said openings are created by making a hole in said band, extending portions of said band adjacent to said opening inward, bending said portions about 180° around said openings to provide reinforcement to said edges of said opening.

21. The system of claim 15 wherein said band is metal.

22. The drive system of claim 15 including a housing for receiving said band wherein said band travels in the interior of said housing.
